(19) United States
(12) Patent Application Publication
(10) Pub. No.: US 2010/0232459 A1
(43) Pub. Date: Sep. 16, 2010

(54) Pulse Laser Light Timing Adjusting Device, Adjusting Method, and Optical Microscope

(76) Inventors: Mamoru Hashimoto, Osaka (JP); Takeo Minamikawa, Osaka (JP); Naoki Tanimoto, Osaka (JP); Minoru Kobayashi, Osaka (JP); Katsumasa Fujita, Osaka (JP); Satoshi Kawata, Osaka (JP); Tsutomu Araki, Osaka (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/227,412

(22) PCT Filed: Nov. 20, 2006
(86) PCT No.: PCT/JP2006/323080

§ 371 Date: Aug. 13, 2009

(30) Foreign Application Priority Data
May 15, 2006 (JP) 2006-135293

(51) Int. Cl. G02F 1/35

(52) U.S. Cl. 372/25

(57) ABSTRACT

To provide a pulse laser light timing adjusting device capable of easily adjusting pulse laser light timing, a timing adjusting method, and an optical microscope. An optical microscope in accordance with the present invention includes mirror pairs 21 and 31 to generates the first timing adjusting optical beam in which the first pulse laser light ω1 is delayed from the second pulse laser light ω2 and the second timing adjusting optical beam in which the second pulse laser light ω2 is delayed from the first pulse laser light having a first wavelength from the optical beam extracted at the beam samplers 15 and 16, a first detector 23 and a second detector 33 to output a first detection signal and a second detection signal based on a nonlinear optical effect, and timing adjusting means 42 to adjust the timing based on the first detection signal and the second detection signal.

### TECHNICAL FIELD

The present invention relates to a pulse laser light adjusting device, an adjusting method, and an optical microscope. In particular, the present invention relates to a pulse laser light adjusting device capable of adjusting the timing of a plurality of pulse laser lights, an adjusting method, and an optical microscope.

### BACKGROUND ART

A CARS (Coherent Anti-Stokes Raman Scattering) microscope has been attracting attention as a microscope capable of observing biological samples with high resolution without staining. In the CARS spectrum, two laser lights having different wavelengths are launched, and the scattered light that is generated when the difference between the frequencies of the incident light matches with the frequency of normal molecular vibrations is observed. That is, the CARS microscope realizes spectroscopic imaging based on a nonlinear optical effect that occurs when two laser lights having different wavelengths are incident to the samples.

In order to generate such a nonlinear optical effect with efficiency, it is necessary to use an ultra-short pulse laser having high peak power. Furthermore, since the spectrum width of molecular vibration to be observed is in the order of several cm⁻¹, the laser is required to have a spectrum line width of 3 to 5 cm⁻¹. Therefore, a pulse laser having a time width of 3 to 5 psec from Fourier transform limit is considered to be optimum.

By launching such two ultra-short pulse laser lights such that they are superimposed in terms of time and space, the nonlinear optical effect is generated. However, a commercially available laser synchronizing system causes temporal fluctuations (timing jitter) of about 1 psec. The CARS is a multiphoton process, and its signal strength depends on incident pulse strength. Therefore, the timing jitter of two pulse laser lights causes fluctuations in the signal, i.e., deterioration of the image. It has been desired to develop a stable high-accuracy synchronous automatic control system for the CARS imaging that requires skilful manipulation, while reducing the timing jitter to the order of femto seconds.

Techniques to synchronize pulse laser lights with high accuracy have been disclosed (see Non-Patent Documents 1 and 2). Non-Patent Document 1, which uses nonlinear optical crystal, differentially detects pulses by using sum-frequency. Then, it has succeeded in suppressing jitter to the region of atto seconds. Furthermore, Non-Patent Document 2 detects optical pulses by a high-speed photodiode. Then, it electrically acquires the time difference between two pico-second lasers by using their components of the 175th order, and succeeds in suppressing jitter to about 21 fs.

[Non-Patent Document 1]

T. R. Schibli et al., Opt. Lett., 28, (2003) pp 947-949

[Non-Patent Document 2]

D. J. Jones et al., Rev. Sci. Inst., 73, (2002) pp 2843-2848

### DISCLOSURE OF THE INVENTION

### Problems to be Solved by the Invention

However, the above-described techniques have the following problems. For example, the control is carried out on a femto-second laser in Non-Patent Document 1. Therefore, when it is applied to a pico-second laser, the available wavelengths are limited by the phase matching conditions because pico-second laser requires thicker nonlinear crystal to obtain enough signal. Furthermore, since Non-Patent Document 2 uses a high-frequency circuit, it is difficult to stable the operation, and therefore it has a problem that it is susceptible to external perturbations. That is, since it requires a high-frequency circuit, it is very difficult to construct the apparatus with a simply structure. Furthermore, it has also a problem that the synchronization becomes out of order as the room temperature changes because of the temperature characteristics of the electronic circuit, environmental electric noise, or the like.

As described above, synchronizing apparatuses for pulse laser light in the related art have a problem that it is very difficult to easily synchronize. The present invention has been made in view of above-mentioned problems. An object of the present invention is to provide a pulse laser light timing adjusting device capable of easily adjusting pulse laser light timing, a timing adjusting method, and an optical microscope using the adjusting device.

### Means for Solving the Problems

In accordance with a first aspect of the present invention, a pulse laser light timing adjusting device to adjust the timing of a plurality of pulse laser lights includes: a first pulse laser light source to launch a first pulse laser light (e.g., a first pulse laser light source 11 in accordance with an embodiment of the present invention); a second pulse laser light source to launch a second pulse laser light (e.g., a second pulse laser light source 12 in accordance with an embodiment of the present invention); a beam sampler to extract a portion of the first pulse laser light and a portion of the second pulse laser light (e.g., a beam samplers 15 and 16 in accordance with an embodiment of the present invention); timing delay means to generate a first timing adjusting optical beam in which the first pulse laser light is delayed from the second pulse laser light and a second timing adjusting optical beam in which the second pulse laser light is delayed from the first pulse laser light from the optical beam extracted at the beam sampler (e.g., a first mirror pair 21 and a second mirror pair 31 in accordance with an embodiment of the present invention); a first detector to receive the first timing adjusting optical beam and output a first detection signal based on an nonlinear optical effect of the first pulse laser light and the second pulse laser light (e.g., a first detector 23 in accordance with an embodiment of the present invention); a second detector to receive the second timing adjusting optical beam and output a second detection signal based on an nonlinear optical effect of the first pulse laser light and the second pulse laser light (e.g., a first pulse laser light source 11 in accordance with an embodiment of the present invention); and timing adjusting mean to adjust the timing of the first pulse laser light source and the second pulse laser light source based on the first detection signal from the first detector and the second detection signal from the second detector (e.g., timing adjusting means 42 in accordance with an embodiment of the present invention). In this way, it is possible to easily adjust the timing.

In accordance with a second aspect of the present invention, a pulse laser light timing adjusting device that is the above-described timing adjusting device further includes light synthesizing means to synthesize the first pulse laser light and the second pulse laser light (e.g., light synthesizing means 14 in accordance with an embodiment of the present invention), wherein the beam sampler extracts a portion of the synthesized light synthesized by the light synthesizing means; the first pulse laser light source launches pulse laser light having a first wavelength; the second pulse laser light source launches pulse laser light having a second wavelength; and the timing delay means generates the first timing adjusting optical beam by a dichroic mirror in which the reflectivity for the first wavelength is lower than the reflectivity for the second wavelength and a mirror to reflect the first pulse laser light that passed the dichroic mirror, and generates the second timing adjusting optical beam by a dichroic mirror in which the reflectivity for the second wavelength is lower than the reflectivity for the first wavelength and a mirror to reflect the second pulse laser light that passed the dichroic mirror. Therefore, it is possible to easily adjust the timing.

In accordance with a third aspect of the present invention, a pulse laser light timing adjusting device that is the above-described timing adjusting device further includes light synthesizing means to synthesize the first pulse laser light and the second pulse laser light, wherein the beam sampler extracts a portion of the synthesized light synthesized by the light synthesizing means; the first pulse laser light source launches pulse laser light having a first wavelength; the second pulse laser light source launches pulse laser light having a second wavelength; and the timing delay means generates the first timing adjusting optical beam by a first optical element having positive group velocity dispersion, and generates the first timing adjusting optical beam by a second optical element having negative group velocity dispersion. In this way, it is possible to easily adjust the timing.

In accordance with a fourth aspect of the present invention, a pulse laser light timing adjusting device is the above-described timing adjusting device, wherein the first and second timing adjusting optical beams are generated by delaying the first pulse laser light or the second pulse laser light based on the difference in the polarization states of the first pulse laser light and the second pulse laser light. In this way, it is possible to adjust the timing even for pulse laser light having the same wavelengths.

In accordance with a fifth aspect of the present invention, a pulse laser light timing adjusting device that is the above-described timing adjusting device further includes a differential amplifier to output a differential signal based on the difference between the first detection signal and the second detection signal, wherein feedback control is carried out such that the differential signal from the differential amplifier is maintained at a constant value. In this way, it is possible to adjust the timing with stability.

In accordance with a sixth aspect of the present invention, an optical microscope includes the above-described pulse laser light timing adjusting device, wherein the first pulse laser light and the second pulse laser light, the timing of both of which is adjusted by the timing adjusting device, are irradiated to a sample. In this way, it is possible to observe with stability.

In accordance with a seventh aspect of the present invention, a pulse laser light timing adjusting method for adjusting the timing of a plurality of pulse laser lights includes: a step for launching a first pulse laser light and a second pulse laser light; a step for extracting a portion of the first pulse laser light and a portion of the second pulse laser light; a step for generating a first timing adjusting optical beam in which the first pulse laser light is delayed from the second pulse laser light and a second timing adjusting optical beam in which the second pulse laser light is delayed from the first pulse laser light from the extracted optical beam; a step for outputting a first detection signal based on an nonlinear optical effect of the first pulse laser light and the second pulse laser light by receiving the first timing adjusting optical beam with a first detector; a step for outputting a second detection signal based on an nonlinear optical effect of the first pulse laser light and the second pulse laser light by receiving the second timing adjusting optical beam with a second detector; and a step for adjusting the timing of the first pulse laser light source and the second pulse laser light source based on the first detection signal and the second detection signal. In this way, it is possible to easily adjust the timing.

In accordance with a eighth aspect of the present invention, a pulse laser light timing adjusting method that is the above-described timing adjusting method further includes a step for synthesizing the first pulse laser light and the second pulse laser light to synthesize a pulse laser light having the first wavelength and a pulse laser light having the second wavelength, wherein the pulse laser light having the first wavelength and the pulse laser light having the second wavelength are launched at the step for launching pulse laser light; a portion of synthesized light generated by synthesizing the pulse laser light having the first wavelength and the pulse laser light having the second wavelength is extracted at the step for extraction; and the first timing adjusting optical beam is generated by a dichroic mirror in which the reflectivity for the first wavelength is lower than the reflectivity for the second wavelength and a mirror to reflect the first pulse laser light that passed the dichroic mirror, and the second timing adjusting optical beam is generated by a dichroic mirror in which the reflectivity for the second wavelength is lower than the reflectivity for the first wavelength and a mirror to reflect the second pulse laser light that passed the dichroic mirror at the step for delaying timing. In this way, it is possible to easily adjust the timing.

In accordance with a ninth aspect of the present invention, a pulse laser light timing adjusting method that is the above-described timing adjusting method further includes a step for synthesizing the first pulse laser light and the second pulse laser light, wherein the pulse laser light having the first wavelength and the pulse laser light having the second wavelength are launched at the step for launching pulse laser light; a portion of synthesized light generated by synthesizing the pulse laser light the first wavelength and the pulse laser light having the second wavelength is extracted at the step for extraction; and the first timing adjusting optical beam is generated by a first optical element having positive group velocity dispersion, and the first timing adjusting optical beam is generated by a second optical element having negative group velocity dispersion at the step for delaying timing. In this way, it is possible to easily adjust the timing.

In accordance with a tenth aspect of the present invention, a pulse laser light timing adjusting method is the above-described timing adjusting method, wherein the first and second timing adjusting optical beams are generated by delaying the first pulse laser light or the second pulse laser light based on the difference in the polarization states of the first pulse laser light and the second pulse laser light. In this way, it is possible to adjust the timing even for pulse laser light having the same wavelengths.

In accordance with a eleventh aspect of the present invention, a pulse laser light timing adjusting method is the above-described timing adjusting method, wherein a differential signal is output based on the difference between the first detection signal and the second detection signal, and feedback control is carried out such that the differential signal is maintained at a constant value at the step for adjusting timing. In this way, it is possible to adjust the timing with stability.

### ADVANTAGEOUS EFFECTS OF THE INVENTION

The present invention can provide a pulse laser light timing adjusting device capable of easily adjusting pulse laser light timing, a timing adjusting method, and an optical microscope using the adjusting device.

### BRIEF DESCRIPTION OF THE DRAWING

FIG. 1 shows the structure of an optical microscope in accordance with the present invention;

FIG. 2 is a schematic view showing the structure of a balance cross-correlator to synchronize pulse laser light in an optical microscope in accordance with the present invention;

FIG. 3A shows the light intensity of pulse laser light in a balance cross-correlator;

FIG. 3B shows the light intensity of pulse laser light in a balance cross-correlator;

FIG. 4A shows the light intensity of pulse laser light in a balance cross-correlator;

FIG. 4B shows the light intensity of pulse laser light in a balance cross-correlator;

FIG. 5 shows a differential signal, a first detection signal, and a second detection signal; and

FIG. 6 shows another structure of timing adjusting means for use in an optical microscope in accordance with the present invention.

### DESCRIPTION OF REFERENCE NUMERALS

11 first pulse laser light source
11 second pulse laser light source
13 mirror
14 light synthesizing means
15 beam sampler
16 beam sampler
17 mirror
18 beam sampler
19 PD
20 balance cross-correlator
21 first mirror pair
22 lens
23 detector
24 differential amplifier
31 second mirror pair
32 lens
33 detector
41 feedback control portion
42 adjusting means
43 LPF
44 oscilloscope
50 microscope optical system
51 object lens
52 sample
53 object lens
54 filer
55 lens
56 light detector
61a-61d half mirrors
62 transparent plate

### BEST MODES FOR CARRYING OUT THE INVENTION

Embodiments to which the present invention is applicable are explained hereinafter. Embodiments are explained only for illustrative purpose in the following explanation, and the present invention is not limited to those embodiments. Parts of descriptions are omitted or simplified as appropriate for the clarification of the explanation. Furthermore, those skilled in the art can easily make modifications, additions, and conversions to each component of the embodiments described below without departing from the scope of the present invention. Note that the same signs are assigned to similar components throughout the drawings, and the explanation of them is omitted as appropriate.

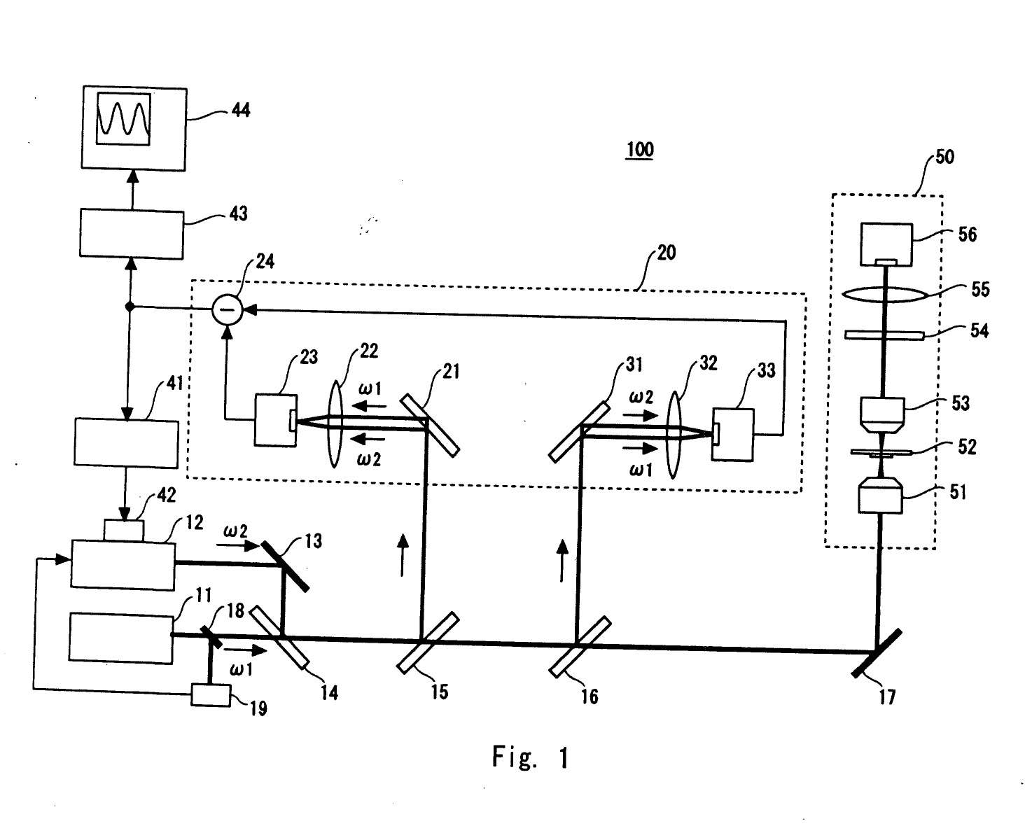

An optical microscope in accordance with the present invention is explained with reference to FIG. 1. FIG. 1 shows the structure of an optical microscope. In this embodiment, the optical microscope is explained as a CARS microscope. In an optical microscope in accordance with this embodiment, two laser lights having different wavelengths are synthesized, and irradiated to a sample.

An optical microscope 100 includes a timing adjusting device to adjust the timing of two pulse laser lights, and a microscope optical system 50 to irradiate the pulse laser lights synchronized by the timing adjusting device. The timing adjusting device includes a first pulse laser light source 11 and a second pulse laser light source 12, a mirror 13, light synthesizing means 14, a beam sampler 15, a beam sampler 16, a beam splitter 18, a photodiode (PD) 19, and balance cross-correlator 20. The balance cross-correlator 20 includes a first mirror pair 21, a lens 22, a first detector 23, a second mirror pair 31, a lens 32, and a second detector 33. Then, two pulse laser lights that are synchronized by using these components are reflected on a mirror 17, and enter into the microscope optical system 50. The microscope optical system 50 includes object lenses 51 and 53, a filter 54, a lens 55, and a light detector 56. Then, anti-Stokes Raman scattering light from a sample 52 is detected by the light detector 56, so that CARS imaging is carried out.

The first pulse laser light source 11 and the second pulse laser light source 12 launch pulse laser lights having different wavelengths. For example, the wavelength λ1 of the first pulse laser light source 11 is 770 nm, and the wavelength 22 of the second pulse laser light source 12 is 840 nm. Furthermore, the second pulse laser light source 12 can carry out wavelength scanning in the range from 800 to 900 nm. In FIG. 1, the pulse laser light from the first pulse laser light source 11 is indicated as ω1, and the pulse laser light from the second pulse laser light source 12 is indicated as ω2. Pico-second pulse lasers are used as the first pulse laser light source 11 and the second pulse laser light source 12. The pulse width of the first pulse laser light source 11 and the second pulse laser light source 12 is, for example, 3 to 5 psec. Furthermore, the first pulse laser light ω1 and the second pulse laser light ω2 have substantially the same pulse width.

Furthermore, the repetition frequencies of the first pulse laser light source 11 and the second pulse laser light source 12 are substantially the same and around 80 MHz. The repetition frequency is based on the time necessary for light to make a round trip in the oscillator. Therefore, the pulses from the two laser light sources 11 and 12 can be synchronized by making the cavity lengths of their oscillators equal to each other. For example, mode-locked titanium sapphire lasers can be used as the first pulse laser light source 11 and the second pulse laser light source 12. Specifically, Tsunami (registered trademark) available from Spectra-Physics K.K. can be used as the first pulse laser light source 11 and the second pulse laser light source 12. Each of the first pulse laser light source 11 and the second pulse laser light source 12 has such a structure that sapphire crystal added with a very small amount of titanium is disposed between two mirrors. By irradiating the sapphire crystal with exciting light, pulse laser light having a certain wavelength is launched from the output mirror. Furthermore, the timing of the pulse laser light can be changed by changing the length of the light oscillator composed of two mirrors.

The pulse laser light ω1 from the first pulse laser light source 11 enters to a light synthesizing means 14. The pulse laser light ω2 from the second pulse laser light source 12 is reflected on a mirror 13, and then enters to the light synthesizing means 14. The light synthesizing means 14 is, for example, a dichroic mirror, and has transmissivity (reflectivity) that changes depending on the wavelength. In this example, the light synthesizing means 14 allows light having a wavelength λ1 to pass through it, and reflects light having a wavelength λ2. Therefore, almost the entire pulse laser light ω1 passes through the light synthesizing means 14, and almost the entire pulse laser light ω2 is reflected on the light synthesizing means 14. The light synthesizing means 14 is disposed such that it is inclined at 45° with respect to each of the optical axes. Consequently, the light synthesizing means 14 efficiently spatially superimposes the pulse laser light ω1 and the pulse laser light ω2.

Furthermore, a beam splitter 18 is disposed between the first pulse laser light source 11 and the light synthesizing means 14. This beam sampler 18 extracts a portion of the first pulse laser light col. Then, the portion of the first pulse laser light ω1 extracted by the beam sampler 18 is detected by a PD (photodiode) 19. The first pulse laser light and the second pulse laser light are temporally superimposed with each other time based on the detection result at the PD 19. That is, portions of the pulses of the first pulse laser light and the second pulse laser light are overlapped with each other. Specifically, PLL (Phase Locked Loop) control is carried out such that the frequency of the oscillator of the pulse laser light source matches with a reference frequency. For example, the frequency of the first pulse laser light source 11 is used as the reference frequency, and the frequency of the second pulse laser light source 12 is matched with that frequency. In this way, portions of the first pulse laser light ω1 and the second pulse laser light ω2 can be temporally overlapped with each other. However, since the accuracy of the PLL is about 1 psec, it is impossible to synchronize with accuracy. That is, since the pulse width is 3 to 5 psec, the occurrence of a deviation of 1 psec significantly deteriorates the CARS image. In addition, there is timing jitter due to external perturbations or the like, so that it is very difficult to stabilize the CARS imaging. Therefore, pulse laser light is synchronized by changing the cavity length based on the output from the balance cross-correlator 20 (which is explained later) in this embodiment of the present invention.

In this manner, the light synthesizing means 14 superimposes two pulse laser lights in terms of time and space. That is, the light synthesizing means 14 synthesizes two pulse laser lights. Therefore, the light launched from the light synthesizing means 14 is synthesized light generated by synthesizing two pulse laser Tights. The two pulse laser lights synthesized by the light synthesizing means 14 enter to a beam sampler 15. The beam sampler 15 extracts a portion of the synthesized light. The synthesized light extracted by the beam sampler 15 becomes a first timing adjusting optical beam. For example, the beam sampler 15 is a beam splitter to split light, and reflects a portion of the synthesized light. The beam sampler 15 is disposed so as to be inclined with respect to the optical axis. The optical beam reflected on the beam sampler 15 becomes the first timing adjusting optical beam. At this point, the first timing adjusting optical beam contains the first pulse laser light ω1 and the second pulse laser light ω2.

Meanwhile, the pulse laser light that passed through the beam sampler 15 enters to a beam sampler 16. Similarly to the beam sampler 15, the beam sampler 16 extracts a portion of the pulse laser light. The pulse laser light extracted by the beam sampler 16 becomes a second timing adjusting optical beam. For example, the beam sampler 16 is a beam splitter to split light, and reflects a portion of the synthesized pulse laser light. The optical beam reflected on the beam sampler 16 becomes the second timing adjusting optical beam. At this point, the second timing adjusting optical beam contains the first pulse laser light ω1 and the second pulse laser light ω2.

In this manner, the beam samplers 15 and 16 extract potions of the pulse laser light, and generate two timing adjusting optical beams. In these two timing adjusting optical beams, the pulse laser light ω1 and the pulse laser light ω2 are superimposed with each other in terms of position and space. That is, the pulse laser light ω1 and the pulse laser light ω2 remain in the synthesized state in the two timing adjusting optical beams. These two timing adjusting optical beams enter into the balance cross-correlator 20. The structure of the balance cross-correlator 20 is explained later. At this point, the beam samplers 15 and 16 extract the light in amounts sufficient to carry out the detection of light at the balance cross-correlator 20. That is, the reflectivity of the beam samplers 15 and 16 is set as low as possible within the range in which the light can be detected at the balance cross-correlator 20. In this way, the intensity of light entering into the microscope optical system 50 can become higher.

The synthesized light that passes through the beam samplers 15 and 16 enters to a mirror 17. The mirror 17 reflects the incident synthesized light in the direction toward the microscope optical system 50. That is, the synthesized light that passes through the beam samplers 15 and 16 becomes the illuminating light (exciting light) of the CARS microscope. Specifically, the synthesized light is concentrated by the object lens 51 and enters to the sample 52. The light from the sample 52 is refracted in the object lens 53 and enters to the filter 53. The filter 53 is a filter allows light in a certain wavelength band to pass through it. Therefore, the CARS light from the sample 52 passes through it, and is detected by the light detector 56. The CARS light from the sample 52 forms an image on the light-reception surface of the light detector 56 by the lens 55. The light detector 56 is, for example, a CCD camera, and takes a CARS image. Meanwhile, the pulse laser lights ω1 and ω2, i.e., the illuminating lights are shielded by the filter 54. That is, the filter 54 separates the illuminating light (exiting light) and the CARS light. Note that a spectroscope may be used as a substitute for the filter 54. In this manner, the CARS image is taken at the light detector 56.

Note that the CARS is a kind of nonlinear Raman scattering. When lights having angular frequencies ω1 and ω2 (ω2>ω1) enter, coherent light having an angular frequency ω3=2ω2−ω1 is irradiated. This coherent light is the CARS. The CARS light is maximized by interaction with molecules of the sample when the value (ω2−ω1) is equal to the Raman active frequency of the sample. Therefore, the molecules constituting the sample 52 can be identified by scanning the wavelengths of one of the pulse laser lights.

Next, the structure of the balance cross-correlator 20 is explained hereinafter. As described above, the balance cross-correlator 20 receives the first timing adjusting optical beam and the second timing adjusting optical beam. Then, the balance cross-correlator 20 precisely synchronizes two pulse laser lights by using these two timing adjusting optical beams. In this example, the balance cross-correlator 20 delays the timing of the pulse laser light by a first mirror pair 21 and a second mirror pair 31.

The first timing adjusting optical beam that is extracted at the beam sampler 15 enters to the first mirror pair 21. The first mirror pair 21 delays the first pulse laser light ω1 from the second pulse laser light ω2 by a value Δt. That is, the optical path length of the first pulse laser light ω1 is longer than the optical path length of the second pulse laser light ω2 by a distance corresponding to the value Lt. Therefore, the first pulse laser light ω1 propagates lagging behind the second pulse laser light ω2. In this example, the first pulse laser light ω1 and the second pulse laser light ω2 are reflected at different places. Then, the first pulse laser light ω1 and the second pulse laser light ω2 enter into a lens 22 at different timing from each other. The lens 22 refracts the first timing adjusting optical beam. This lens 22 concentrates the first pulse laser light ω1 and the second pulse laser light ω2 at the same place. Then, the first pulse laser light ω1 and the second pulse laser light ω2 that are concentrated by the lens 22 enter into a first detector 23. That is, the light-reception surface of the first detector 23 is located at the place where the first pulse laser light ω1 and the second pulse laser light ω2 are concentrated.

Meanwhile, the second timing adjusting optical beam that is extracted at the beam sampler 16 enters to the second mirror pair 31. The second mirror pair 31 delays the second pulse laser light ω2 from the first pulse laser light ω1 by a value Δt. That is, the optical path length of the second pulse laser light ω2 is longer than the optical path length of the first pulse laser light ω1 by a distance corresponding to the value Δt. At this point, if the Δt is a positive value, the first pulse laser light ω1 is delayed from the second pulse laser light ω2 by a value −Δt. The second pulse laser light ω2 propagates lagging behind the first pulse laser light ω1. In this example, the first pulse laser light ω1 and the second pulse laser light ω2 are reflected at different places. Then, the first pulse laser light ω1 and the second pulse laser light ω2 enter into a lens 32 at different timing from each other. The lens 32 refracts the second timing adjusting optical beam. This lens 32 concentrates the first pulse laser light ω1 and the second pulse laser light ω2 at the same place. Then, the first pulse laser light ω1 and the second pulse laser light ω2 that are concentrated by the lens 32 enter into a second detector 33. That is, the light-reception surface of the second detector 33 is located at the place where the first pulse laser light ω1 and the second pulse laser light ω2 are concentrated.

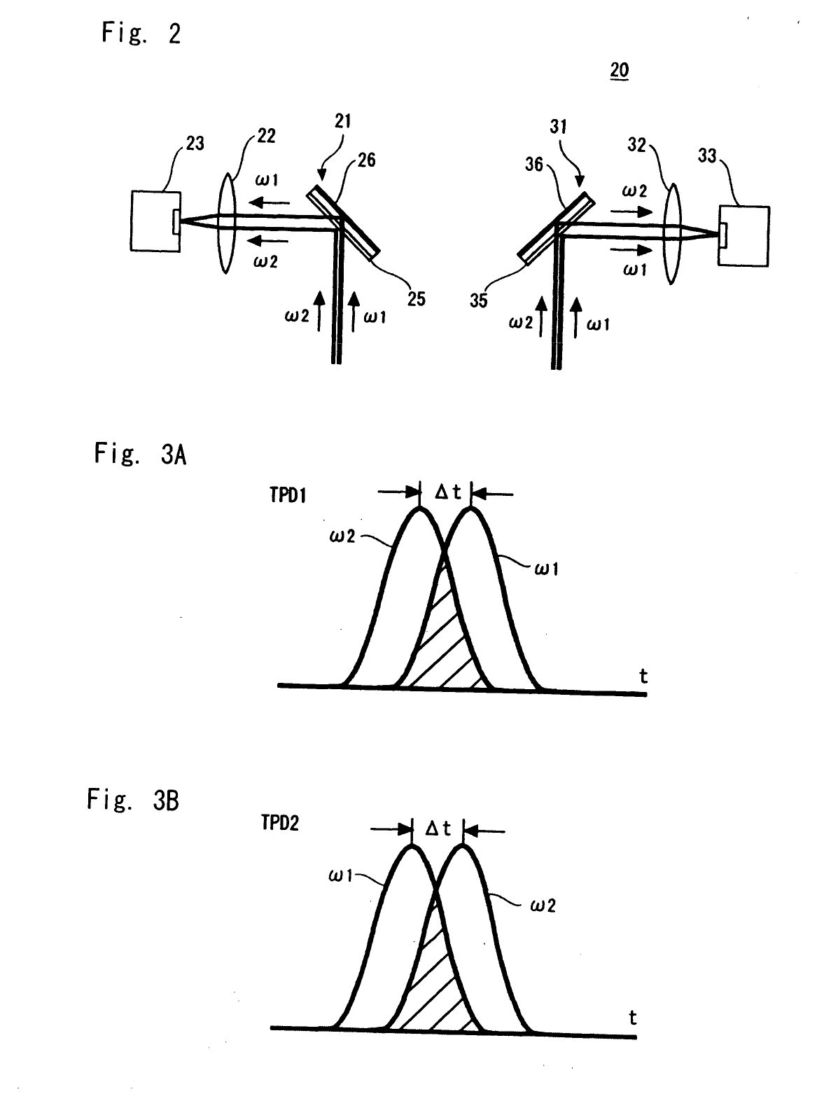

The structures of the first mirror pair 21 and the second mirror pair 31 are explained hereinafter with reference to FIG. 2. FIG. 2 shows the structure of a balance cross-correlator 20. The first mirror pair 21 includes a dichroic mirror 25 and a reflecting mirror 26. Furthermore, the second mirror pair 31 includes a dichroic mirror 35 and a reflecting mirror 36. The dichroic mirrors 25 and 35 have reflectivity and transmissivity both of which change depending on the wavelength.

The dichroic mirror 25 has different transmissivity for a wavelength λ1 and a wavelength λ2. The transmissivity of the dichroic mirror 25 for the wavelength λ1 is higher than the transmissivity of the dichroic mirror 25 for the wavelength λ2. In other words, reflectivity of the dichroic mirror 25 for the wavelength λ1 is lower than the reflectivity of the dichroic mirror 25 for the wavelength λ2. Specifically, the dichroic mirror 25 allows light having a wavelength λ1 to pass through it, and reflects light having a wavelength λ2. That is, the dichroic mirror 25 has high transmissivity for the light having the wavelength λ1 and high reflectivity for the light having the wavelength λ2. Therefore, the dichroic mirror 25 allows almost the entire first pulse laser light ω1 to pass through it, and reflects almost the entire second pulse laser light ω2.

In this example, the dichroic mirror 25 is disposed in front of the reflecting mirror 26. In other words, the reflecting mirror 26 is disposed on the back side of the dichroic mirror 25. Therefore, only the light that passes through the dichroic mirror 25 enters to the reflecting mirror 26. At this point, since almost the entire second pulse laser light ω2 is reflected on the dichroic mirror 25, it does not enter to the reflecting mirror 26. On the other hand, almost the entire first pulse laser light ω1 passes through the dichroic mirror 25 and enters to the reflecting mirror 26. The reflecting mirror 26 is a plane mirror in which a metal film is formed on a grass substrate by vapor deposition, and reflects almost the entire incident light regardless of the wavelength. Therefore, almost the entire first pulse laser light oil is reflected on the reflecting mirror 26, and almost the entire second pulse laser light ω2 is reflected on the dichroic mirror 25.

Furthermore, the dichroic mirror 25 and the reflecting mirror 26 are disposed with a predetermined distance therebetween. That is, the reflection plane of the dichroic mirror 25 and the reflection plane of the reflecting mirror 26 are disposed with a predetermined distance therebetween. This distance is determined based on the time by which the first pulse laser light ω1 is delayed. Specifically, the distance between the reflection planes is established such that the timing delay Δt becomes several pico seconds. The timing delay Δt is shorter than the pulse width of the first pulse laser light ω1 and the second pulse laser light ω2. For example, if the reflection planes are disposed apart from each other by around 1 mm, it delays by about 3 psec per one way. Therefore, the distance between the reflection planes is preferably equal to or less than 1 mm. The dichroic mirror 25 and the reflecting mirror 26 are disposed adjacent and opposite to each other in such a manner. Furthermore, the reflection plane of the dichroic mirror 25 and the reflection plane of the reflecting mirror 26 are disposed in parallel with each other. In this example, the reflection plane of the first mirror pair 21 is inclined with respect to the optical axis of the first timing adjusting optical beam. Note that although the reflection plane of the first mirror pair 21 is inclined at 45° with respect to the optical axis, it is not limited to this configuration. For example, the incident angle of the timing adjusting optical beam with respect to the reflection plane of the first mirror pair 21 may be reduced to nearly 0°.

As described above, the first pulse laser light ω1 and the second pulse laser light ω2 are reflected on the different reflection planes. Therefore, the first pulse laser light ω1 and the second pulse laser light ω2 are reflected at the different places. Consequently, a timing delay is generated between the first pulse laser light ω1 and the second pulse laser light ω2. In addition, the first pulse laser light ω1 and the second pulse laser light ω2 propagates on different optical axes.

As described above, the first pulse laser light ω1 and the second pulse laser light ω2 that are reflected on the first mirror pair 21 enter to the lens 22. The lens 22 refracts light such that the positions of the first pulse laser light ω1 and the second pulse laser light ω2 coincide with each other. That is, the optical axis of the lens 22 is located on the middle between the optical axes of the first pulse laser light ω1 and the second pulse laser light ω2. Therefore, the lens 22 refracts lights such that the optical axes of the first pulse laser light ω1 and the second pulse laser light ω2 intersect with each other. Then, the light-reception surface of the detector 23 is located at the intersection of the two pulse laser lights. Consequently, the optical path lengths from the dichroic mirror 25 to the detector 23 for the first pulse laser light ω1 and the second pulse laser light ω2 are substantially equal to each other. That is, a certain timing delay Δt is generated between the first pulse laser light ω1 and the second pulse laser light ω2 on the paths from the beam sampler 15 to the detector 23. Accordingly, the first pulse laser light ω1 is delayed from the second pulse laser light ω2 by the value Δt. Note that the timing delay Δt is the time corresponding to the distance between the dichroic mirror 25 and the reflecting mirror 26.

The first pulse laser light ω1 and the second pulse laser light ω2 are concentrated, and enter into the first detector 23. In this example, the first detector 23 is a two-photon detector, and detects two-photon absorption. That is, the first detector 23 outputs a first detection signal depending on the number of occurrences of the two-photon absorption on the light-reception surface. Specifically, the first detector 23 is a GaAsP photodiode. For example, G1117 available from Hamamatsu Photonics K.K. can be used for it. The light-reception sensitivity of the first detector 23 is 300 to 680 nm. Therefore, it does not detect one-photon absorption by a photon having a wavelength λ1 or a photon having a wavelength λ2.

In the first detector 23, the band gap of the PN-junction is larger than energy corresponding to one photon having the wavelength λ1. If the band gap is Eg, Planck constant is h, and the frequency of light having the wavelength λ1 is ν1, it is expressed as Eg>h ν1. Therefore, when only a photon having the wavelength λ1 enters, no electron exceeds the band gap. Needless to say, the wavelength λ2 is longer than the wavelength λ1. Therefore, when only a photon having the wavelength λ2 enters, no electron exceeds the band gap likewise. That is, the first detector 23 does not have sensitivity for light having wavelengths λ1 and λ2 longer than 680 nm. Meanwhile, when a photon having the wavelength λ1 and a photon having wavelength λ2 enter simultaneously, electron in a valence band exceeds the band gap. That is, electron that is excited by the two-photon absorption exceeds the bang gap, and is raised to the conduction band. When two photons are absorbed simultaneously, conduction electron (free electron) and positive hole are generated. Then, a first detection signal can be obtained by amplifying the current generated by the conduction electron and the positive hole. Consequently, the first detection signal is output from the first detector 23 based on the two-photon absorption.

A photodiode having a certain band gap can be used for the first detector 23. Note that the band gap is established in accordance with the wavelength λ1 and λ2 of the pulse laser light. That is, a photodiode having a band gap with which no conduction electron is generated by one-photon absorption but conduction electron is generated by two-photon absorption should be selected. That is, in addition to the photodiode, a photomultiplier or the like can be also used as the first detector 23 in which the sum of the energy of a photon having the wavelength λ1 and a photon having the wavelength λ2 is larger than the band gap. That is, the only requirement for the detector is that it should output a detection signal in accordance with two-photon absorption. In other words, it is detected by a detector that has no sensitivity for one-photon absorption but has sensitivity for two-photon absorption. Note that the two-photon absorption occurs in proportion to the square of the incident light intensity. Therefore, the first detector 23 can obtain a first detection signal in proportion to the square of the light intensity.

Meanwhile, the second timing adjusting optical beam enters to the second mirror pair 31. Similarly to the first mirror pair 21, the second mirror pair 31 includes a dichroic mirror 35 and a reflecting mirror 36. However, the dichroic mirror 35 has transmissivity distribution and reflectivity distribution different from those of the dichroic mirror 25. That is, the reflectivity and the transmissivity are different between the dichroic mirror 35 and the dichroic mirror 25. In contrast to the dichroic mirror 25, the dichroic mirror 35 reflects light having a wavelength λ1, and allows light having a wavelength λ2 to pass through it. The dichroic mirror 25 and the dichroic mirror 35 are designed differently such that they reflect lights having different wavelengths. Specifically, the transmissivity and the reflectivity are changed by changing the type, film thickness, or the like of the dielectric thin film coating applied on the glass substrate.

The transmissivity of the dichroic mirror 35 for the wavelength 2, 1 is lower than the transmissivity of the dichroic mirror 35 for the wavelength λ2. In other words, the reflectivity of the dichroic mirror 35 for the wavelength 2, 1 is higher than the reflectivity of the dichroic mirror 35 for the wavelength λ2. Specifically, the dichroic mirror 35 reflects light having the wavelength λ1, and allows light having the wavelength 22 to pass through it. That is, the dichroic mirror 35 has high reflectivity for the light having the wavelength λ1 and high transmissivity for the light having the wavelength λ2. Therefore, the dichroic mirror 35 reflects almost the entire first pulse laser light ω1, and allows almost the entire second pulse laser light ω2 to pass through it.

In this example, the dichroic mirror 35 is disposed in front of the reflecting mirror 36. In other words, the reflecting mirror 36 is disposed on the back side of the dichroic mirror 35. Therefore, only the light that passes through the dichroic mirror 35 enters to the reflecting mirror 36. At this point, since almost the entire first pulse laser light ω1 is reflected on the dichroic mirror 35, it does not enter to the reflecting mirror 36. On the other hand, almost the entire second pulse laser light ω2 passes through the dichroic mirror 35 and enters to the reflecting mirror 36. The reflecting mirror 36 reflects almost the entire incident light regardless of the wavelength. Therefore, almost the entire second pulse laser light ω2 is reflected on the reflecting mirror 36, and almost the entire first pulse laser light ω1 is reflected on the dichroic mirror 35.

Furthermore, similarly to the first mirror pair 21, the dichroic mirror 35 and the reflecting mirror 36 are disposed with a predetermined distance therebetween. That is, the arrangement of the dichroic mirror 35 and the reflecting mirror 36 is the same as the arrangement of the dichroic mirror 25 and the reflecting mirror 26 in the first mirror pair 21. Therefore, it is possible to delay the second pulse laser light ω2 from the first pulse laser light col. The timing delay is shorter than the pulse width of the first pulse laser light ω1 and the second pulse laser light ω2. Furthermore, the value of the timing delay Δt in the first mirror pair 21 and the value of the timing delay Δt in the second mirror pair 31 are equal to each other. That is, the first pulse laser light ω1 is delayed by the value Δt by the first mirror pair 21, and the second pulse laser light ω2 is delayed by the value Δt by the second mirror pair 31.

In this manner, the second pulse laser light ω2 is delayed in the second timing adjusting optical beam. Note that the timing delay Δt is the time corresponding to the distance between the dichroic mirror 35 and the reflecting mirror 36. As described above, the lengths of the timing delays Δt are the same between the first mirror pair 21 and the second mirror pair 31. Furthermore, the signs of the timing delays Δt are opposite between the first mirror pair 21 and the second mirror pair 31 in terms of positive and negative. Note that if the timing delay by the first mirror pair 21 is Δt, the timing delay by the second mirror pair 31 becomes −Δt.

The optical beam reflected on the second mirror pair 31 enters into the second detector 33 through the lens 32. Note that the lens 32 and the second detector 33 have a similar configuration to that of the lens 22 and the first detector 23. That is, the lens 32 concentrates the first pulse laser light ω1 and the second pulse laser light ω2 that are reflected at different places in the second mirror pair 31. Then, the light-reception surface of the second detector 33 is located at the place where the light is concentrated by the lens 32. Furthermore, similarly to the first detector 23, the second detector 33 is a two-photon detector. Therefore, a second detection signal is output based on the two-photon absorption of a photon having the wavelength λ1 and a photon having wavelength λ2. Note that photodiodes of the same type are preferably used for the first detector 23 and the second detector 33.

Incidentally, the repetition frequency of the pulse laser light is 80 MHz. Therefore, the time interval at which the pulse laser light enters is sufficiently fast in comparison with the response speed of the first detector 23 and the second detector 33. Therefore, the first detector 23 and the second detector 33 output the average values of two-photon absorption generated by a plurality of pulses as the detection signals.

As described above, the first pulse laser light ω1 is delayed in the first mirror pair 21, and the second pulse laser light ω2 is delayed in the second mirror pair 31. Therefore, it is detected in the state where the first pulse laser light ω1 is delayed in one of the two timing adjusting optical beams, and it is detected in the state where the second pulse laser light ω2 is delayed in the other of the two timing adjusting optical beams. That is, the balance cross-correlator 20 generates, from the optical beam extracted at the beam samplers 15 and 16, the first timing adjusting optical beam in which the first pulse laser light ω1 is delayed from the second pulse laser light ω2 and the second timing adjusting optical beam in which the second pulse laser light ω2 is delayed from the first pulse laser light ω1. Then, the first timing adjusting optical beam is detected by the first detector 23, and the second timing adjusting optical beam is detected by the second detector 33. Then, the first detection signal from the first detector 23 and the second detection signal from the second detector 33 are input to a differential amplifier 24 shown in FIG. 1. The differential amplifier 24 acquires the difference between the first detection signal and the second detection signal. Then, it outputs a differential signal based on this difference.

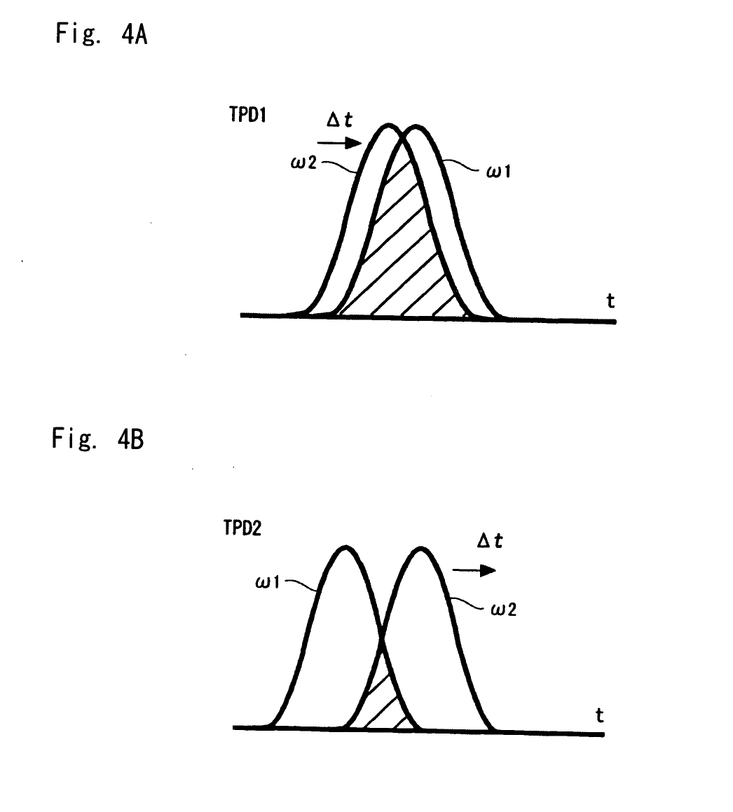

The light intensity of the pulse laser light and each signal are explained hereinafter with reference to FIGS. 3A, 3B, 4A, 4B, and 5. FIGS. 3A, 3B, 4A, and 4B show changes in pulse laser light intensity over time. FIGS. 3A, 3B, 4A, and 4B show light intensity after the timing delay is generated by the mirror pair. In particular, FIGS. 3A and 4A show the light intensity of the pulse laser light reflected on the first mirror pair 21, and FIGS. 3B and 4B show the light intensity of the pulse laser light reflected on the second mirror pair 31. The following explanation is made with an assumption that the deviation of the pulse laser light before entering into the balance cross-correlator 20 is timing jitter τ.

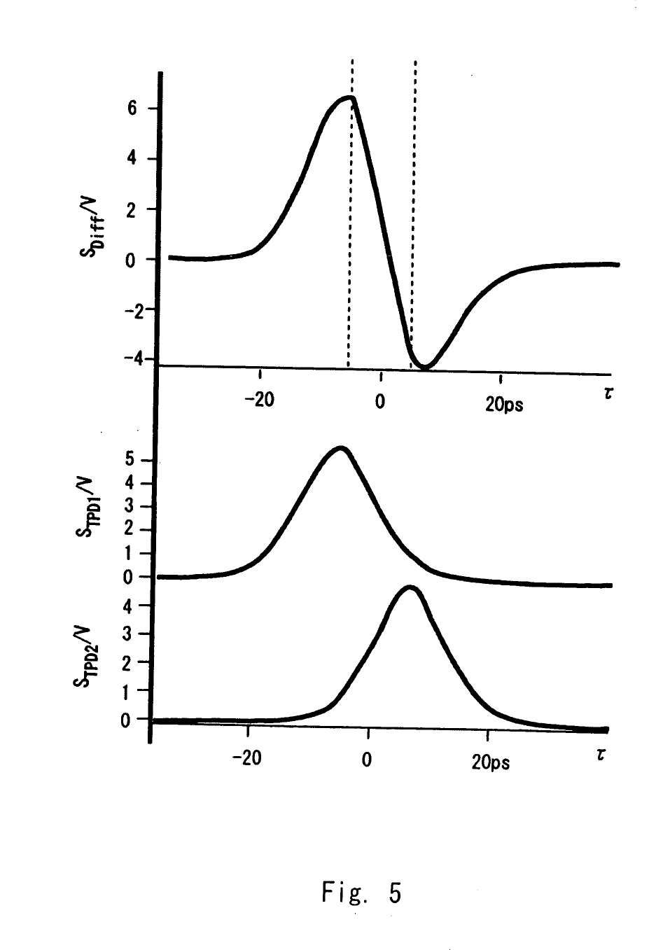

Note that FIGS. 3A and 3B show light intensity in the case of the timing jitter τ=0. That is, FIGS. 3A and 3B show light intensity in the case where the first pulse laser light ω1 and the second pulse laser light ω2 are synchronized with each other before entering into the balance cross-correlator 20. FIGS. 4A and 4B show light intensity in the case where the timing jitter is not zero. That is, FIGS. 4A and 4B show light intensity in the case where the second pulse laser light ω2 is delayed from the first pulse laser light ω1 before entering into the balance cross-correlator 20. The following explanation is made with an assumption that pulse laser light is distributed in accordance with a Gaussian distribution. Furthermore, FIG. 5 shows detection signals and a differential signal.

Firstly, the case where τ=0 is explained with reference to FIGS. 3A and 3B. That is, the explanation is made with an assumption that the peak timing of the first pulse laser light ω1 and the peak timing of the second pulse laser light ω2 coincide with each other before they enter to the first mirror pair 21. At this point, the peak timing of the first pulse laser light ω1 is delayed from the peak timing of the second pulse laser light ω2 by a value Δt in the first timing adjusting optical beam reflected on the first mirror pair 21 as shown in FIG. 3A. Meanwhile, the peak timing of the second pulse laser light ω2 is delayed from the peak timing of the first pulse laser light ω1 by the value Δt in the second timing adjusting optical beam reflected on the second mirror pair 31 as shown in FIG. 3B.

In this example, assume that the deviation amount of the peak timing after being reflected on the mirror pair is Δd. The deviation amount Δd of the peak timing is equal to the timing delay Δt. Therefore, the deviation amount Δd of the first timing adjusting optical beam caused by the first mirror pair 21 coincides with the deviation amount Δd of the second timing adjusting optical beam caused by the second mirror pair ω1. The size of the area where the first pulse laser light ω1 and the second pulse laser light ω2 overlap with each other in the first timing adjusting optical beam, i.e., the hatched area in FIG. 3A is equal to the size of the area where the first pulse laser light ω1 and the second pulse laser light ω2 overlap with each other in the second timing adjusting optical beam, i.e., the hatched area in FIG. 3B. That is, assuming that the first pulse laser light ω1 and the second pulse laser light ω2 have the same Gaussian distributions, the areas of overlap portions shown as the hatched areas are equal to each other since they are shifted in ahead and behind by the same deviation amount Δd.

At this point, the first detector 23 and the second detector 33, both of which are two-photon detectors, output detection signals in proportion to the square of the light intensity in the overlap areas. Therefore, the first detection signal and the second detection signal are equal to each other. When the first pulse laser light ω1 and the second pulse laser light ω2 are synchronized with each other, the first detection signal and the second detection signal have the same value. When the timing jitter τ is zero, the differential signal becomes zero.

Next, the case where the timing jitter τ is not zero is explained with reference to FIGS. 4A and 4B. In this example, a case where the second pulse laser light ω2 is delayed from the first pulse laser light ω1 before they enter to the first mirror pair 21 is explained. In such a case, the sizes of overlapped areas of the first pulse laser light ω1 and the second pulse laser light ω2 shown as the hatched areas in FIGS. 4A and 4B are different from each other. That is, the delay in the second pulse laser light ω2 before it enters to the second mirror pair 31 is emphasized by the second mirror pair 31. Consequently, since the second pulse laser light ω2 is further delayed at the second mirror pair 31, the size of the overlap portion becomes smaller as shown in FIG. 4B. Meanwhile, the delay in the second pulse laser light ω2 before it enters to the first mirror pair 21 is cancelled by the first mirror pair 21. Consequently, the deviation amount Δd of the peak timing in the first timing adjusting optical beam becomes smaller than that in the second timing adjusting optical beam. Therefore, the area of the overlap portion shown as the hatched area in FIG. 4A becomes larger.

When the timing jitter is not zero, the differential signal does not become zero. Furthermore, the amount of the differential signal is changed in accordance with the timing deviation that is caused before entering into the balance cross-correlator 20. For example, it is possible to determine which pulse laser light is delayed by determining the sign, i.e., positive or negative, of the differential signal. Furthermore, it is also possible to determine the level of deviation amount by determining the amount of the differential signal. At this point, if the timing jitter τ is completely canceled by the timing delay Δt by the first mirror pair 21, the deviation amount Δd becomes zero, i.e., Δd=0. Consequently, the first detection signal is maximized. On the other hand, if the timing jitter τ is completely canceled by the timing delay −Δt by the second mirror pair 31, the deviation amount Δd becomes zero, i.e., Δd=0. Consequently, the second detection signal is maximized.

Assuming that the above-mentioned differential signal is S_{diff}, the first detection signal is S_{PTD1}, and the second detection signal is S_{PTD2}, these signals are expressed by the equations 1.

S_{TPD1}=∫|g₁(t−τ)+g₂(t−Δt)|²dt

S_{TPD2}=∫|g₁(t)+g₂(t−τ−Δt)|²dt

S_{Diff}=∫g₁(t−τ)g₂(t−Δt)dt−∫g₁(t)g₂(t−τΔt)dt [Equation 1]

In the equations 1, g1 is intensity of the first pulse laser light, g2 is intensity of the second pulse laser light, and t is time.

In this example, the differential signal S_{diff}, the first detection signal S_{PTD1}, and the second detection signal S_{PTD2} become as shown in FIG. 5. In FIG. 5, the horizontal axis indicates timing jitter τ, and the vertical axis indicates signal intensity. Furthermore, FIG. 5 shows, from top to bottom, the differential signal S_{diff}, the first detection signal S_{PTD1}, and the second detection signal S_{PTD2}. Note that they are expressed by the formula: differential signal S_{diff}=first detection signal S_{PTD1}−second detection signal S_{PTD2}.

At this point, if the timing jitter τ is zero, the differential signal S_{diff} becomes zero. That is, since the first detection signal S_{PTD1} becomes equal to the second detection signal S_{PTD2}, the differential signal S_{diff} becomes zero. Furthermore, if the timing jitter τ is significantly large in comparison with the value Δt, the amplitude of the detection signal becomes substantially zero. Furthermore, in the vicinity of τ=0, the amplitude of the differential signal S_{diff} decreases with the increase of the value τ. In this example, in the area between the dotted lines in FIG. 5, the differential signal S_{diff} changes substantially linearly in accordance with the timing jitter τ. In the area between the dotted lines, it is possible to measure the direction and the amount of the deviation based on the differential signal S_{diff}. That is, in this area, the amplitude of the differential signal S_{diff} corresponds to the deviation of pulse laser lights.

The first detection signal S_{PTD1} has its peak around the point where the deviation amount Δd is equal to −5 psec. This peak point corresponds to the timing delay Δt the first mirror pair 21. At this point, when the first detection signal S_{PTD1} is at its peak, the deviation amount Δd becomes zero. That is, the peak of the first pulse laser light ω1 and the peak of the second pulse laser light ω2 coincide with each other. Then, as the timing jitter τ gets apart from the peak point, the amplitude of the first detection signal S_{PTD1} becomes smaller. Meanwhile, the second detection signal S_{PTD2} has its peak around the point where the timing jitter τ is equal to +5 psec. At this point, when the second detection signal S_{PTD2} is at its peak, the deviation amount Δd becomes zero. That is, the peak of the first pulse laser light ω1 and the peak of the second pulse laser light ω2 coincide with each other. Then, as the timing jitter τ gets apart from the peak point, the amplitude of the second detection signal S_{PTD2} becomes smaller.

As described above, there is an area where the differential signal S_{diff} changes substantially linearly in accordance with the timing jitter τ. The pulse laser light can be easily synchronized by carrying out feedback control within this range. Specifically, the timing jitter τ is reduced within the range where the differential signal S_{diff} changes linearly by using PLL control. Then, the differential signal S_{diff} is input to a feedback control portion 41. The feedback control portion 41 includes, for example, an arithmetic processing device such as a digital PID controller. In this example, the feedback control is carried out such that the differential signal S_{diff} becomes zero.

The feedback control portion 41 controls a timing adjusting means 42 mounted on the second pulse laser light source 12 based on the differential signal S_{diff}. The timing adjusting means 42 includes an actuator or the like to change the oscillator length of the second pulse laser light source 12. The feedback control portion 41 changes the oscillator length by driving the actuator provided in the timing adjusting means 42. That is, the cavity length can be controlled by driving the actuator of the timing adjusting means 42. Therefore, the timing of the pulse laser light is changed. Then, it drives the timing adjusting means 42 such that the differential signal S_{diff} gets closer to zero. The measurements of the differential signal S_{diff} are carried out at certain intervals, and the feedback control is carried out based on these measurements. In this way, it is possible to synchronize the pulse laser light with stability.

Specifically, when the second pulse laser light ω2 is delayed by timing jitter the first detection signal S_{PTD1} becomes larger and the second detection signal S_{PTD2} becomes smaller. Therefore, when the differential signal S_{diff} is positive, the control is carried out such that the first pulse laser light ω1 is delayed with respect to the second pulse laser light ω2. In this way, the timing jitter τ can be reduced. On the other hand, when the first pulse laser light ω1 is delayed by timing jitter τ, the first detection signal S_{PTD1} becomes smaller and the second detection signal S_{PTD2} becomes larger. Therefore, when the differential signal S_{diff} is negative, the control is carried out such that the second pulse laser light ω2 is delayed with respect to the first pulse laser light ω1. In this way, the timing jitter τ can be reduced. Then, when the timing jitter τ is zero, it is at the balanced state with the differential signal S_{diff} being zero. Within the range where the differential signal S_{diff} changes linearly, the value of the differential signal S_{diff} can be converted into the timing jitter τ. Then, the pulse timing is adjusted based on the differential signal S_{diff}.

The timing jitter τ can be reduced by carrying out the above-described feedback control. Furthermore, the timing jitter is measured by observing the differential signal S_{diff} through a low-pass filter 43 with an oscilloscope 44 in this embodiment. In this example, the timing jitter t, which is originally around 1 psec in a band of 150 Hz, can be reduced to 8 fsec by the feedback control. In this manner, it becomes possible to synchronize pulse laser light with stability by carrying out the feedback control.

Note that although control to synchronize pulse laser light is explained in the above explanation, embodiments in accordance with the present invention is not limited to this control. For example, pulse laser light may be controlled such that the timing is shifted. Specifically, it is possible to control such that the shift in the incident timing of pulse laser light is maintained at a constant value. In such a case, the feedback control is carried out such that the differential signal S_{diff} becomes a value other than zero. This value is determined in accordance with the shift in the incident timing. That is, the incident timing can be controlled by carrying out the feedback control such that the differential signal S_{diff} is maintained at a constant value. Furthermore, control may be also carried out such that the incident timing varies.

As described above, since the feedback control is carried out, the synchronization is continuously maintained. Therefore, even in the case where timing jitter occurs due to wavelength scanning, the synchronization can be easily achieved. Therefore, it is suitable for an optical microscope that requires wavelength scanning, such as a CARS microscope. Needless to say, the pulse laser light timing adjusting device is not limited to application to a CARS microscope. For example, it is also applicable to nonlinear spectroscopy using two pulse lasers. Specifically, it can be used for a two-photon excitation laser microscope, a pump probe spectromicroscope, or the like. That is, it is suitable for a laser light microscope in which pulse laser light from the above-described timing adjusting device is irradiated to a sample as illuminating light (exiting light).

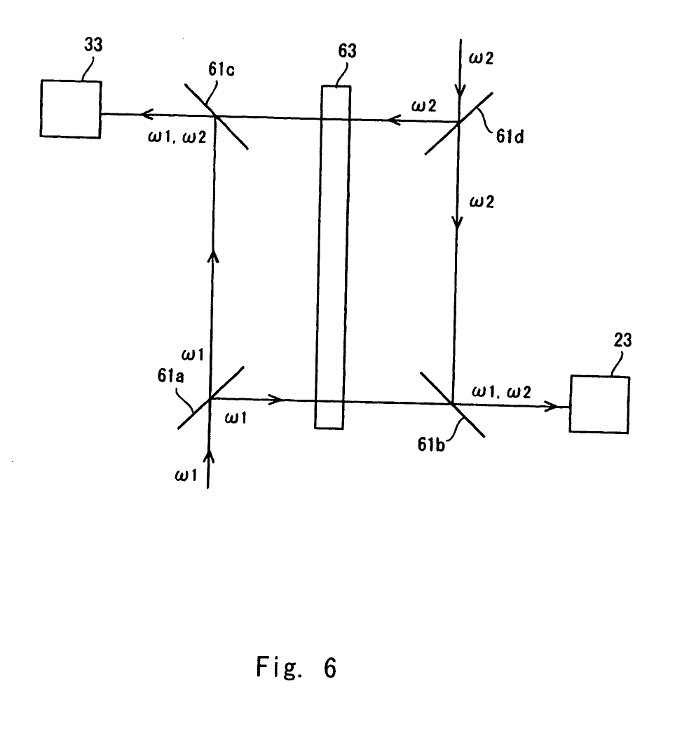

Furthermore, although a first timing adjusting optical beam in which one of two pulse laser lights is delayed and a second timing adjusting optical beam in which the other of the two pulse laser lights is delayed are generated by the first mirror pair 21 and the second mirror pair 31 in the above explanation, the present invention is not limited to this example. That is, although the first mirror pair 21 and the second mirror pair 31 are used as timing delay means to delay the timing in the above explanation, embodiments in accordance with the present invention are not limited to this example. For example, delay means 60 having a structure shown in FIG. 6 can be used.

In the delay means 60 shown in FIG. 6, pulse laser lights that are not yet synthesized are launched into it. That is, a first pulse laser light ω1 and a second pulse laser light ω2 are separately enter into it. In this example, the optical path lengths for the first pulse laser light ω1 and the second pulse laser light ω2 before entering into the delay means 60 are made equal to each other.

The delay means 60 includes four half mirrors 61a-61d. They are collectively referred to as “half mirrors 61”. The half mirrors 61 allow roughly half of incident light to pass through them, and reflect roughly half of it. These four half mirrors 61a-61d are arranged in a vertically and horizontally symmetrical manner. For example, the center of each of the half mirrors 61a-61d is located at one of the four corners of a square. Furthermore, the half mirror 61a and the half mirror 61d, which are diagonally located with each other, are arranged in parallel. Similarly, the half mirror 61b and the half mirror 61c, which are diagonally located with each other, are also arranged in parallel. Furthermore, the half mirror 61a and the half mirror 61b are arranged in the directions that intersect at right angles. Furthermore, each of the half mirrors 61a-61d is disposed such that it is inclined at 45° with respect to the optical axes of the pulse laser lights ω1 and ω2.

The first pulse laser light ω1 first enters to the half mirror 61a. The half mirror 61a allows a portion of the first pulse laser light ω1 to pass through it, and reflect a portion of the first pulse laser light ω1. Consequently, the first pulse laser light ω1 splits into two portions. One of the split optical beams enters to the half mirror 61b, and the other enters to the half mirror 61c. A portion of the first pulse laser light ω1 that enters to the half mirror 61b passes through the half mirror 61b and enters into a first detector 23. A portion of the first pulse laser light ω1 that enters to the half mirror 61c is reflected on the half mirror 61 and enters into a second detector 33

Meanwhile, the second pulse laser light ω2 first enters to the half mirror 61d. Therefore, the second pulse laser light ω2 splits into two portions in a similar manner to the first pulse laser light col. One of the optical beams split by the half mirror 61d enters to the half mirror 61b, and the other enters to the half mirror 61c. A portion of the first pulse laser light ω1 that enters to the half mirror 61b is reflected on the half mirror 61 and enters into the first detector 23. A portion of the first pulse laser light ω1 that enters to the half mirror 61c passes through the half mirror 61 and enters into the second detector 33.

In this manner, the first pulse laser light ω1 and the second pulse laser light ω2 are synthesized by the half mirrors 61b and 61c. In this example, the delay means 60 includes a transparent plate 63. The transparent plate 63 is arranged on the optical path between the half mirror 61c and the half mirror 61d, and on the optical path between the half mirror 61a and the half mirror 61b. The transparent plate 63 is, for example, composed of transparent glass. The transparent plate 63 has a refractive index higher than that of the air. Therefore, light that passed through the transparent plate 63 has an optical path difference in accordance with the refractive index and the thickness of the transparent plate.

The first pulse laser light ω1 that is reflected on the half mirror 61a and enters to the half mirror 61b and the second pulse laser light ω2 that is reflected on the half mirror 61d and enters to the half mirror 61c pass through the transparent plate 63. Meanwhile, the first pulse laser light ω1 that passes through the half mirror 61a and enters to the half mirror 61c and the second pulse laser light ω2 that passes through the half mirror 61d and enters to the half mirror 61b does not pass the glass plate but propagates entirely through the air. Therefore, a timing delay Δt is generated in pulse laser lights in the synthesized light synthesized at the half mirrors 61b and 61c. This timing delay Δt is determined on the material, the thickness, and the like of the transparent plate 63. The transparent plate 63 is preferably composed of material having small wavelength dispersion.

Specifically, the first pulse laser light ω1 that passed through the transparent plate 63 is delayed from the second pulse laser light ω2 in the synthesized light at the half mirror 61b. Meanwhile, the second pulse laser light ω2 that passed through the transparent plate 63 is delayed from the first pulse laser light ω1 in the synthesized light at the half mirror 61c. Therefore, the first detector 23 receives the first timing adjusting optical beam in which the first pulse laser light ω1 is delayed with respect to the second pulse laser light ω2. Meanwhile, the second detector 33 receives the second timing adjusting optical beam in which the second pulse laser light ω2 is delayed with respect to the first pulse laser light ω1. In this example, the first detector 23 and the second detector 33 are similar two-photon detectors to those shown in FIG. 2. Therefore, the timing can be adjusted by a similar structure to that shown in FIG. 2.

In this manner, since the delay means 60 shown in FIG. 6 uses no dichroic mirror, it can generates a timing delay even for pulse laser lights having wavelengths closer to each other. That is, since the structure shown in FIG. 2 uses dichroic mirrors, the range of the adjustable difference in wavelengths is restricted by the performance of the dichroic mirrors. In other words, if the difference in wavelengths is too small to be separated by the dichroic mirror, the structure shown in FIG. 2 can not delay the timing. The structure shown in FIG. 6 generates a timing delay in the state where the first pulse laser light ω1 and the second pulse laser light ω2 propagates along different optical paths. In this way, it can adjust pulse laser lights having wavelengths that are closer to each other.

Meanwhile, the structure shown in FIG. 2 generates a timing delay for the light beam synthesized at the light synthesizing means 14. Therefore, it can adjust the timing in a more reliable manner. That is, since a portion of the synthesized light entering into the microscope optical system 50 is splitted, the differential signal in the balance cross-correlator 20 precisely reflects the timing jitter τ of the synthesized light. In other words, the structure shown in FIG. 2 can eliminate a minute difference in the optical path lengths that is caused by the fact the first pulse laser light ω1 and the second pulse laser light ω2 propagate along different optical paths. In this manner, it can adjust the timing with accuracy.

Needless to say, timing delay means to delay the timing is not limited to the structures shown in FIGS. 2 and 6. That is, various types of timing delay means can be constructed by combining dichroic mirrors, half mirrors, reflection mirrors, and the likes. For example, in the structure shown in FIG. 6, the timing can be delayed, without providing the transparent plate 63, by arranging the center of each of the half mirrors 61 at one of the four corners of a rectangle. In such a case, an optical path difference is created by the difference in propagation lengths in the air. In this manner, a structure to generate a first timing adjusting optical beam in which the first pulse laser light ω1 is delayed from the second pulse laser light ω2 and a second timing adjusting optical beam in which the second pulse laser light ω2 is delayed from the first pulse laser light ω1 may be used as the timing delay means. Then, the first timing adjusting optical beam is received by the first detector 23 and the second timing adjusting optical beam is received by the second detector 33, so that accurate timing adjustment can be achieved with a simple structure.

Furthermore, it is also possible to construct the timing delay means with optical elements having group velocity dispersion. For example, an optical element having positive group velocity dispersion can delay light having a short wavelength. On the other hand, an optical element having negative group velocity dispersion can delay light having a long wavelength. Therefore, an optical element having positive group velocity dispersion may be used as a substitute for the first mirror pair 21, and an optical element having negative group velocity dispersion may be used as a substitute for the second mirror pair 31. That is, the first timing adjusting optical beam may be detected by extracting it with a beam sampler through an optical element having positive group velocity dispersion, and the second timing adjusting optical beam may be detected through an optical element having negative group velocity dispersion. An optical fiber, a diffraction grating pair, or the like can be used for such an optical element having group velocity dispersion.

Note that the structure of the beam samplers 15 and 16 is not limited to the one shown in FIG. 1. For example, the optical beam extracted at the beam sampler 15 may enter to a half mirror. In such a case, the beam sampler 16 is unnecessary. The only requirement for the beam sampler is that it should have a structure capable of extracting a portion of the first pulse laser light ω1 and a portion of the second pulse laser light ω2. Therefore, an optical beam may be extracted before being synthesized at the light synthesizing means 14 as shown in FIG. 6. Furthermore, the first pulse laser light source 11 and the second pulse laser light source 12 are not limited to pico-second pulse laser lights. For example, a femto-second laser light source can be also used.

Furthermore, in addition to the two-photon absorption, multi-photon absorption may be used to adjust the timing of pulse laser light. That is, the timing may be adjusted based on a detection signal from a detector that detects multi-photon absorption. In this way, for example, the timing of three or more pulse laser lights can be adjusted. Furthermore, in addition to the multi-photon absorption, the timing of pulse laser light may be adjusted by using a nonlinear optical effect. That is, the timing may be adjusted by using a detection signal from a detector that detects a nonlinear optical effect. In this manner, devices that output detection signals based on multi-photon absorption or devices that output detection signals based on nonlinear optical effects may be used as the first detector 23 and the second detector 33.

Furthermore, by using the structure shown in FIG. 6, it is possible to adjust the timing for pulse laser lights having the same wavelength. Therefore, it is also effective for a case where pulse laser lights having substantially equivalent wavelengths are synthesized, such as light heterodyne detection. That is, it is also possible to apply to the first pulse laser light ω1 and the second pulse laser light ω2 having the same wavelength. In such a case, in addition to the structure shown in FIG. 6, the separation and the synthesis may be carried out by using the difference in the polarization state. For example, when the first pulse laser light ω1 and the second pulse laser light ω2 have linear polarization, the first pulse laser light ω1 and the second pulse laser light ω2 can be separated by using a polarized beam splitter or the like. That is, a polarized beam splitter or the like may be used as a substitute for the dichroic mirror shown in FIGS. 1 and 2. Then, the first pulse laser light ω1 and the second pulse laser light ω2 are separated and synthesized according to the difference in the polarization planes. In this way, pulse laser light that is synthesized by light synthesizing means is separated. Then, the separated pulse laser lights are synthesized after the timing of one of them is delayed. That is, an optical path length difference is produced between the first pulse laser light ω1 and the second pulse laser light ω2. In this way, first and second timing adjusting optical beams are generated. Then, the timing is adjusted by using a similar method to the above-described method. By matching light beams in terms of time and space in this manner, it can be used in the field of high-speed optical communication in the future. As described above, the separation and synthesis of pulse laser light can be carried out according to the difference in the polarization state by using a polarized beam splitter or the like. Therefore, it is possible to adjust the timing of pulse laser light having the same wavelength.

Furthermore, it is also possible to delay the timing without using a polarized beam splitter. For example, it is possible to delay the timing by using a double refraction element such as a Babinet compensator and a liquid crystal element. Specifically, first and second pulse laser lights having linear polarization are synthesized by arranging them such that their polarization planes intersect each other at right angles. That is, two timing adjusting optical beams are generated by superimposing two laser lights in such a state that the polarization planes of the first and second pulse laser lights intersect at right angles. Then, each of the two timing adjusting optical beams enters, for example, to a Babinet compensator. The Babinet compensator includes a pair of optical wedges having optic axes that intersect each other at right angles. Then, the optical path length of one of the optical wedges is changed by moving that optical wedge by the screw of a micrometer. Furthermore, the other optical wedge is fixed, so that it has a constant optical path length. At this point, the pair of the optical wedges is arranged such that the optic axis of each optical wedge coincides with the corresponding one of polarization planes of the first pulse laser light and the second pulse laser light. In this way, the timing of only one of the pulse laser lights can be delayed based on the difference in the polarization state. That is, a timing delay according to the optical path length difference of the pair of optical wedges can be produced for the two pulse laser lights. Then, the first pulse laser light is delayed by one of two Babinet compensators, and the second pulse laser light is delayed by the other one. In this manner, a timing adjusting optical beam in which the timing of one of two pulse laser lights is delayed can be produced by using the difference between the polarization states of the two pulse laser lights. Therefore, it is possible to produce a timing delay, without separating the first pulse laser light and the second pulse laser light, by using a double refraction element. Furthermore, it is also possible to adjust the timing of pulse laser light having the same wavelength.

### INDUSTRIAL APPLICABILITY

The present invention can easily adjust the timing of pulse laser light, and therefore can be applied to an optical microscope such as a CARS microscope, a two-photon excitation laser microscope, a pump probe spectromicroscope.

1. A pulse laser light timing adjusting device to adjust the timing of a plurality of pulse laser lights comprising:
a first pulse laser light source to launch a first pulse laser light;
a second pulse laser light source to launch a second pulse laser light;
light synthesizing means to generate synthesized light in a state where the first pulse laser light and the second pulse laser light are spatially superimposed by synthesizing the first pulse laser light and the second pulse laser light;
a beam sampler to extract a portion of the synthesized light synthesized by the light synthesizing means, the synthesized light being in the state where the first pulse laser light and the second pulse laser light are spatially superimposed;
timing delay means to generate a first timing adjusting optical beam in which the first pulse laser light is delayed from the second pulse laser light and a second timing adjusting optical beam in which the second pulse laser light is delayed from the first pulse laser light from the portion of the synthesized light extracted at the beam sampler based on a difference in wavelengths or polarization states between the first pulse laser light and the second pulse laser light, the synthesized light being in the state where the first pulse laser light and the second pulse laser light are spatially superimposed;
a first detector to receive the first timing adjusting optical beam and output a first detection signal having a strength varying depending on a nonlinear optical effect of the first pulse laser light and the second pulse laser light;
a second detector to receive the second timing adjusting optical beam and output a second detection signal having a strength varying depending on a nonlinear optical effect of the first pulse laser light and the second pulse laser light; and
timing adjusting means to adjust the timing of the first pulse laser light source and the second pulse laser light source based on the first detection signal from the first detector and the second detection signal from the second detector.

2. The pulse laser light timing adjusting device according to claim 1, wherein:
the first pulse laser light source launches pulse laser light having a first wavelength;
the second pulse laser light source launches pulse laser light having a second wavelength; and
the timing delay means generates the first timing adjusting optical beam by a dichroic mirror in which the reflectivity for the first wavelength is lower than the reflectivity for the second wavelength and a mirror to reflect the first pulse laser light having the first wavelength that passed the dichroic mirror, and generates the second timing adjusting optical beam by a dichroic mirror in which the reflectivity for the second wavelength is lower than the reflectivity for the first wavelength and a mirror to reflect the second pulse laser light having the second wavelength that passed the dichroic mirror.

3. The pulse laser light timing adjusting device according to claim 1, wherein:
the first pulse-laser light source launches pulse laser light having a first wavelength;
the second pulse laser light source launches pulse laser light having a second wavelength; and
the timing delay means generates the first timing adjusting optical beam by a first optical element having positive group velocity dispersion, and generates the second timing adjusting optical beam by a second optical element having negative group velocity dispersion.

4. The pulse laser light timing adjusting device according to claim 1, wherein: the light synthesizing means generates the synthesized light in which the polarization plane of the first pulse laser light and the polarization plane of the second pulse laser light intersect at right angles; and
the first and second timing adjusting optical beams are generated by a double refraction element provided in the timing delay means based on the difference in the polarization planes of the first and second pulse laser lights.

5. The pulse laser light timing adjusting device according to claim 1, further comprising a differential amplifier to output a differential signal based on the difference between the first detection signal and the second detection signal,
wherein feedback control is carried out such that the differential signal from the differential amplifier is maintained at a constant value.

6. An optical microscope comprising a pulse laser light timing adjusting device according to claim 1,
wherein the first pulse laser light and the second pulse laser light, the timing of both of which is adjusted by the timing adjusting device, are irradiated to a sample.

7. A pulse laser light timing adjusting method for adjusting the timing of a plurality of pulse laser lights comprising:
launching a first pulse laser light and a second pulse laser light;
synthesizing the first pulse laser light and the second pulse laser light to generate synthesized light in a state where the first pulse laser light and the second pulse laser light are spatially superimposed;
extracting a portion of the synthesized light synthesized by the light synthesizing means, the synthesized light being in the state where the first pulse laser light and the second pulse laser light are spatially superimposed;
generating a first timing adjusting optical beam in which the first pulse laser light is delayed from the second pulse laser light and a second timing adjusting optical beam in which the second pulse laser light is delayed from the first pulse laser light from the portion of the synthesized light in the state where the first pulse laser light and the second pulse laser light are spatially superimposed based on a difference in wavelengths or polarization states between the first pulse laser light and the second pulse laser light;
outputting a first detection signal having a strength varying depending on a nonlinear optical effect of the first pulse laser light and the second pulse laser light by receiving the first timing adjusting optical beam with a first detector;
outputting a second detection signal having a strength varying depending on a nonlinear optical effect of the first pulse laser light and the second pulse laser light by receiving the second timing adjusting optical beam with a second detector; and
adjusting the timing of the first pulse laser light source and the second pulse laser light source based on the first detection signal and the second detection signal.

8. The pulse laser light timing adjusting method according to claim 7, wherein:
the pulse laser light having the first wavelength and the pulse laser light having the second wavelength are launched at the launching pulse laser light; and
the first timing adjusting optical beam is generated by a dichroic mirror in which the reflectivity for the first wavelength is lower than the reflectivity for the second wavelength and a mirror to reflect the first pulse laser light that passed the dichroic mirror, and the second timing adjusting optical beam is generated by a dichroic mirror in which the reflectivity for the second wavelength is lower than the reflectivity for the first wavelength and a mirror to reflect the second pulse laser light that passed the dichroic mirror at the generating.

9. The pulse laser light timing adjusting method according to claim 7, wherein:
the pulse laser light having the first wavelength and the pulse laser light having the second wavelength are launched at the launching pulse laser light;
a portion of synthesized light generated by synthesizing the pulse laser light the first wavelength and the pulse laser light having the second wavelength is extracted at the extracting; and
the first timing adjusting optical beam is generated by a first optical element having positive group velocity dispersion, and the first timing adjusting optical beam is generated by a second optical element having negative group velocity dispersion at the generating.

10. The pulse laser light timing adjusting method according to claim 7, wherein:
the synthesized light in which the polarization plane of the first pulse laser light and the polarization plane of the second pulse laser light intersect at right angles is generated at the generating synthesized light; and
the first and second timing adjusting optical beams are generated by a double refraction element based on the difference in the polarization planes of the first and second pulse laser lights at the generating first and second timing adjusting optical beams.

11. The pulse laser light timing adjusting method according to claim 7, wherein a differential signal is output based on the difference between the first detection signal and the second detection signal, and feedback control is carried out such that the differential signal is maintained at a constant value at the adjusting timing.
